(19) United States
(12) Patent Application Publication
(10) Pub. No.: US 2026/0044365 A1
(43) Pub. Date: Feb. 12, 2026

(54) FRAMEWORK AND PROCESSES FOR ARTIFICIAL INTELLIGENCE GUIDED INTERACTIVE AGENTS

(71) Applicant: Workato, Inc., Palo Alto, CA (US)

(72) Inventors: Jasper Madrone, Great Barrington, MA (US); Robert Fujara, Hochheim am Main (DE); Aleksei Dereviankin, Bucharest (RO); Bhaskar Roy, Los Altos, CA (US)

(21) Appl. No.: 19/297,979

(22) Filed: Aug. 12, 2025

Related U.S. Application Data
(60) Provisional application No. 63/682,232, filed on Aug. 12, 2024.

(51) Int. Cl. G06F 9/48; H04L 51/02

(52) U.S. Cl. CPC G06F 9/485; H04L 51/02

(57) ABSTRACT

A system may initiate generation of an interactive agent to perform one or more tasks, the interactive agent including at least one module of a set of modules, each of the set of modules providing a tool configured to perform a task. The system may determine the at least one module for the interactive agent including selecting the at least one module from among the set of modules. In some cases, the system may initiate a process of the interactive agent to perform the one or more tasks using the at least one module. The various modules may represent functionality that may be interchanged to curate the functionality of the interactive agent. In some implementations, an artificial intelligence model may provide interaction, select modules, configure tools, or perform other guidance.

### BACKGROUND

The present disclosure relates to a platform for providing a framework and set of tools for constructing interactive artificial intelligence (AI) agents. For instance, the disclosure relates to a system and method for providing a framework and processes for AI-guided interactive agents.

Previous systems, such as an OpenAI™, Boomi™, Wrike™, or Pega™ assistant, may provide a no-code/low code development environment for implementing business processes or integrations; however, business process automation systems have historically involved fixed sequences of steps to accomplish a goal and that are fixed in advance and are not adaptable, among other deficiencies.

In addition, some current software-implemented business processes call applications in the context of a highly privileged integration account without taking into account the calling user's permissions, which reduces security and safety.

While some AI systems provide an extension capability, which allows incorporation of data from business systems via external function definitions, there is no intelligence or adaptability for when to call external functions or how to do it.

Accordingly, previous technologies fail in numerous respects, such as those noted above.

### SUMMARY

This disclosure describes technology that addresses the above-noted deficiencies of existing solutions by providing technology for providing a framework and processes for artificial intelligence guided interactive agents, among other improvements. In some aspects, the techniques described herein relate to a computer-implemented method including: initiating, by one or more processors, generation of an interactive agent to perform one or more tasks, the interactive agent including at least one module of a set of modules, each of the set of modules providing a tool configured to perform a task; determining, by the one or more processors, the at least one module for the interactive agent including selecting the at least one module from among the set of modules; and initiating, by the one or more processors, a process of the interactive agent to perform the one or more tasks using the at least one module.

In some aspects, the techniques described herein relate to a computer-implemented method, further including: determining, by the one or more processors, a design-time update to the at least one module of the interactive agent; based on determining the design-time update, triggering, by the one or more processors, a reindexing process for the at least one module; propagating, by the one or more processors, a configuration update across a plurality of affected interactive agents including the interactive agent, the plurality of affected interactive agents including the at least one module; and applying, by the one or more processors, a function state in a function state table indicating the design-time update for the at least one module.

In some aspects, the techniques described herein relate to a computer-implemented method, wherein the reindexing process includes: suspending, by the one or more processors, a definition of the interactive agent; executing, by the one or more processors, an updated module based on the configuration update; and resuming, by the one or more processors, the definition of the interactive agent.

In some aspects, the techniques described herein relate to a computer-implemented method, further including: determining, by the one or more processors, a run-time update to a component of the interactive agent; based on determining the run-time update, suspending, by the one or more processors, at least one process of the interactive agent; and broadcasting, by the one or more processors, one or more events to one or more software recipes associated with a plurality of affected interactive agents including the interactive agent, the one or more events indicating a configuration update.

In some aspects, the techniques described herein relate to a computer-implemented method, wherein: the set of modules are interchangeable in the interactive agent to affect a plurality of tasks of the interactive agent, the at least one module including a defined input/output schema that connects the at least one module to an external service used to perform the task.

In some aspects, the techniques described herein relate to a computer-implemented method, further including: initiating, by the one or more processors, the task of the tool of the at least one module including determining initial process attributes; based on determining that user-specific credentials are associated with the tool, determining, by the one or more processors, the user-specific credentials; and executing, by the one or more processors, a tool call for the tool using the user-specific credentials, the task including executing the tool call.

In some aspects, the techniques described herein relate to a computer-implemented method, further including: based on determining that an approval rule of the tool is defined, evaluating, by the one or more processors, an approval condition for the approval rule; and executing, by the one or more processors, a tool call for the tool based on the approval condition being satisfied.

In some aspects, the techniques described herein relate to a computer-implemented method, wherein: the interactive agent includes a specialized digital assistant configured to perform one or more domain-specific tasks, the interactive agent including a plurality of modules combined to perform the one or more tasks, each of the set of modules including a tool with a defined input/output schema that uses a runtime connection for a user.

In some aspects, the techniques described herein relate to a computer-implemented method, wherein: the interactive agent is configured to retrieve data from and store data to one or more third-party databases using the defined input/output schema.

In some aspects, the techniques described herein relate to a computer-implemented method, wherein: the interactive agent includes a chat interface configured to receive user input via a chat prompt, identify the task based on the chat prompt, and perform one or more tool calls to perform the task.

In some aspects, the techniques described herein relate to a computer-implemented method, wherein: the at least one module of the interactive agent includes a plurality of artificial intelligence modules, each of the plurality of artificial intelligence modules interacting with an artificial intelligence model, the plurality of artificial intelligence modules being communicatively coupled with each other to perform the one or more tasks.

In some aspects, the techniques described herein relate to a system including: one or more processors; and a computer-implemented memory storing instructions that, when executed by the one or more processors, causes the system to perform operations including: initiating, by the one or more processors, generation of an interactive agent to perform one or more tasks, the interactive agent including at least one module of a set of modules, each of the set of modules providing a tool configured to perform a task; determining, by the one or more processors, the at least one module for the interactive agent including selecting the at least one module from among the set of modules; and initiating, by the one or more processors, a process of the interactive agent to perform the one or more tasks using the at least one module.

In some aspects, the techniques described herein relate to a system, wherein the operations further include: determining, by the one or more processors, a design-time update to the at least one module of the interactive agent; based on determining the design-time update, triggering, by the one or more processors, a reindexing process for the at least one module; propagating, by the one or more processors, a configuration update across a plurality of affected interactive agents including the interactive agent, the plurality of affected interactive agents including the at least one module; and applying, by the one or more processors, a function state in a function state table indicating the design-time update for the at least one module.

In some aspects, the techniques described herein relate to a system, wherein the reindexing process includes: suspending, by the one or more processors, a definition of the interactive agent; executing, by the one or more processors, an updated module based on the configuration update; and resuming, by the one or more processors, the definition of the interactive agent.

In some aspects, the techniques described herein relate to a system, wherein the operations further include: determining, by the one or more processors, a run-time update to a component of the interactive agent; based on determining the run-time update, suspending, by the one or more processors, at least one process of the interactive agent; and broadcasting, by the one or more processors, one or more events to one or more software recipes associated with a plurality of affected interactive agents including the interactive agent, the one or more events indicating a configuration update.

In some aspects, the techniques described herein relate to a system, wherein: the set of modules are interchangeable in the interactive agent to affect a plurality of tasks of the interactive agent, the at least one module including a defined input/output schema that connects the at least one module to an external service used to perform the task.

In some aspects, the techniques described herein relate to a system, wherein the operations further include: initiating, by the one or more processors, the task of the tool of the at least one module including determining initial process attributes; based on determining that user-specific credentials are associated with the tool, determining, by the one or more processors, the user-specific credentials; and executing, by the one or more processors, a tool call for the tool using the user-specific credentials, the task including executing the tool call.

In some aspects, the techniques described herein relate to a system, wherein the operations further include: based on determining that an approval rule of the tool is defined, evaluating, by the one or more processors, an approval condition for the approval rule; and executing, by the one or more processors, a tool call for the tool based on the approval condition being satisfied.

In some aspects, the techniques described herein relate to a system, wherein: the interactive agent includes a specialized digital assistant configured to perform one or more domain-specific tasks, the interactive agent including a plurality of modules combined to perform the one or more tasks, each of the set of modules including a tool with a defined input/output schema that uses a runtime connection for a user.

In some aspects, the techniques described herein relate to a system, wherein: the interactive agent is configured to retrieve data from and store data to one or more third-party databases using the defined input/output schema.

Other implementations of one or more of these aspects or other aspects include corresponding systems, apparatus, and computer programs, configured to perform the various actions and/or store various data described in association with these aspects. These and other implementations, such as various data structures, are encoded on tangible computer storage devices. Numerous additional features may, in some cases, be included in these and various other implementations, as discussed throughout this disclosure. It should be understood that the language used in the present disclosure has been principally selected for readability and instructional purposes, and not to limit the scope of the subject matter disclosed herein.

### BRIEF DESCRIPTION OF THE DRAWINGS

This disclosure is illustrated by way of example, and not by way of limitation in the figures of the accompanying drawings in which like reference numerals are used to refer to similar elements.

FIG. 1 is a block diagram illustrating an example integration management system encompassed by the technology.

FIG. 2 is a block diagram of an example computing system.

FIG. 3 is a block diagram illustrating an example architecture and data flow for providing a framework and set of tools for constructing interactive agents.

FIG. 4 illustrates an example process for a process run.

FIGS. 5A-5B illustrate a flowchart of an example method for providing interactive agent configuration and updates.

FIG. 6 illustrates a flowchart of an example method for using an AI-guided interactive agent.

FIG. 7 illustrates a block diagram showing an example method in which an artificial intelligence model may be used to generate operations.

### DETAILED DESCRIPTION

The innovative technology disclosed in this application is capable of, for instance, providing a framework and set of tools for constructing interactive artificial intelligence (AI) agents. For instance, the disclosure relates to a system and method for providing a framework and processes for AI-guided interactive agents. The technology improves understanding among devices and systems as well as improving access to systems and knowledge.

In some implementations, the technology may dynamically determine an appropriate path along a process being executed using an interactive agent, for example, without describing, up front, the path. As discussed herein, the technology may improve the computing system's ability to reason and automatically access appropriate systems and at appropriate times. If issues arise, the systems may request user input or assistance.

In some implementations, the technology provides the ability to create new skills for a component, such as an interactive agent, when it appropriate (e.g., at run time, upon a request, or when it is otherwise called for), where it proposes a new skill, drafts a recipe for it, and works with developers to get it deployed. For example, it can create a capability on its own using previously coded building blocks (e.g., those provided by Workato™). If defined as a requirement, the technology may contact a human to review and approve the capabilities, recipes, code, etc., before generated code, software recipe, or workflow goes into production. For instance, the technology may allow fact mining and process mining based on past practices, and it may take the learning and add it to a knowledge base. Accordingly, these and other features, especially when used in various combinations, improve over the Background, for example, through interaction of multiple features, operations, and/or systems, such as in an integrated system.

The technology may include a modular framework that allows users to connect practically any AI service or model and allows them to orchestrate business processes leveraging a service's (e.g., Workato's™) recipes as its skills. The technology may provide a way for a user/builder to connect various types of AI service, UI (user interface), piece of logic, or code to take action in the system. These and other features or systems may be decoupled and, thereby swappable. For these and other reasons, the technology is differentiated from those systems in the Background.

In some implementations, the technology allows a system or user to overwrite the parameters that AI is using to call the functions, for example, in flight and/or before the AI calls that function. Business process approvals and runtime connections are also described in further detail below.

In some instances, the platform/technology may be granted a service account, or it may use a user scoped connection (on behalf of that user), which reduces the risk of exposing data to which the user does not have access. Because an AI may not be aware of business process approvals or other parts of the framework, certain actions or access may be executed no matter what if an AI attempts to call corresponding functions. The technology may facilitate conforming or restricting processes or operations based on processes, as noted in further detail elsewhere herein.

Aspects of the technology may be referred to as a genie, genie manager 140, process AI, or interactive agent herein, and it may include a general or specified purpose platform, implemented as a software framework and set of tools for rapidly constructing interactive agents (“genies”) that perform and assist in functions.

In some implementations, these agents may leverage a set of reusable capabilities including chat or other user interfaces, connection to selected applications, and AI systems. The AI component(s) may guide interactions among these capabilities, for instance, based on the task at hand and previous interactions, which may thereby produce dynamic interaction patterns that progress towards a stated goal. Interactions may involve multiple cooperating and interacting agents. Depending on the implementation, systems built on the example framework can learn from past behavior. In some cases, the system is extensible with new capabilities, including the possibility of incorporating new processes that are AI-generated. The system supports transparency (e.g., where users are informed of actions taken), traceability (e.g., through creation of a record of actions), and security (e.g., by ensuring no data is retrieved to which the end user does not have permission).

As noted above, business process automation systems have historically involved fixed sequences of steps to accomplish a goal. The framework described here builds upon previous system capabilities, but it may go beyond those previously existing. In Workato™ and similar systems, process steps may be AI generated via a coding assistant, but generally they do not involve a set of steps selected by an AI at runtime. Allowing the runtime selection, as the technology described herein may, provides a higher level of automation (e.g., where the user need not select discrete steps) and a more intelligent system that may combine and process data in ways not directly anticipated by the end user, to accomplish a business task.

In addition, the framework may take into account the calling user's permissions, which may provide a level of security and safety. The framework may also allow an AI to decide when to call an external function, for example, in the process of fielding a user request, whereas previous systems may only provide the parameters for calling such a request.

The framework described herein may make use of these and other configurations, and, in some implementations, may incorporate other features, such as: 1) maintenance of a reusable library of callable tools, including facilities for evolution of their schema over time; 2) independence of any particular AI provider or its extension framework; 3) providing a system for coordination of tool calls and knowledge retrieval, and managing user interactions and approvals; 4) maintenance of context within and across agents, including passing a user context to tool invocations; and 5) the optionally providing higher level coordination and learning functions, such as building a framework of dynamically interacting agents or using past activity to generate new processes. These features support highly dynamic interaction scenarios, with ease of authoring, traceability and transparency, and security.

Depending on the implementation, the overall system may be cloud-based and may use capabilities of the Workato™ platform, although other services, tools, integrations, and platforms may be used. It may provide hosted storage, and it may provide the ability to transmit data to and from external systems.

The AI-driven dynamic execution scenarios supported by the system may extend beyond those in previous business integration systems and enable more flexible and intelligent processes to be constructed. These processes can add significant value in the form of increased computational efficiency, user productivity, and/or reduction of manual, error prone and/or repetitive steps. These and other features, as noted elsewhere herein, also improve computational efficiency, reduce bandwidth utilization, provide enhanced computer functionality, and provide various other technical benefits.

The technology may integrate disparate computing systems, automate or partially automate processes, and leverage AI to facilitate intelligent decision-making. The technology may facilitate rapid adoption of interactive integration and automation solutions including AI capabilities by a wide range of users, and it may provide to them sophisticated, dynamic AI-driven functionality that was not available in previous systems.

These and other benefits, operations, and features are described by way of example in the implementations herein. It should be noted that while certain examples are provided, these are not exhaustive, and others are possible and contemplated herein.

With reference to the figures, reference numbers may be used to refer to components found in any of the figures, regardless of whether those reference numbers are shown in the figures being described. Further, where a reference number includes a letter referring to one of multiple similar components (e.g., component 000a, 000b, and 000n), the reference number may be used without the letter to refer to one or all of the similar components.

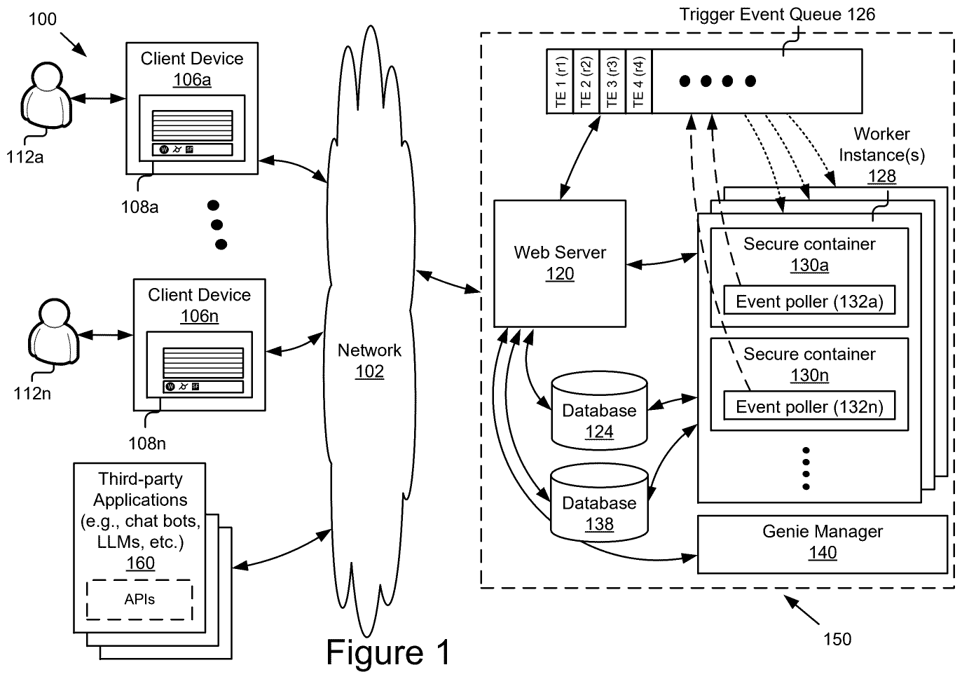

FIG. 1 is a block diagram illustrating an example system 100 in which the technology may be used. The illustrated example system 100 includes client devices 106a . . . 106n, a server system 150, and third-party applications 160, which are communicatively coupled via a network 102 for interaction with one another. For example, the client devices 106a . . . 106n may be respectively coupled to the network 102 and may be accessible by users 112a . . . 112n (also referred to individually and collectively as 112). The server system 150 and third-party applications 160 may be communicatively coupled to the network 102. The use of the nomenclature “a” and “n” in the reference numbers indicates that any number of those elements having that nomenclature may be included in the system 100. The architecture, location of services, and other features are described by way of example.

The network 102 may include any number of networks and/or network types. For example, the network 102 may include, but is not limited to, one or more local area networks (LANs), wide area networks (WANs) (e.g., the Internet), virtual private networks (VPNs), mobile (cellular) networks, wireless wide area network (WWANs), WiMAX® networks, Bluetooth® communication networks, peer-to-peer networks, other interconnected data paths across which multiple devices may communicate, various combinations thereof, etc. Data transmitted by the network 102 may include packetized data (e.g., Internet Protocol (IP) data packets) that is routed to designated computing devices coupled to the network 102. In some implementations, the network 102 may include a combination of wired and wireless networking software and/or hardware that interconnects the computing devices of the system 100. For example, the network 102 may include packet-switching devices that route the data packets to the various computing devices based on information included in a header of the data packets.

The client devices 106a . . . 106n (also referred to individually and collectively as 106) include computing systems having data processing and communication capabilities. In some implementations, a client device 106 may include a processor (e.g., virtual, physical, etc.), a memory, a power source, a network interface, and/or other software and/or hardware components, such as a display, graphics processor, wireless transceivers, keyboard, camera, sensors, firmware, operating systems, drivers, and/or various physical connection interfaces (e.g., USB, HDMI, etc.), etc. The client devices 106a . . . 106n may couple to and communicate with one another and the other entities of the system 100 via the network 102 using a wireless and/or wired connection.

Examples of client devices 106 may include, but are not limited to, mobile phones (e.g., feature phones, smart phones, etc.), tablets, laptops, desktops, netbooks, server appliances, servers, virtual machines, TVs, set-top boxes, media streaming devices, portable media players, navigation devices, personal digital assistants, etc. While two or more client devices 106 are depicted in FIG. 1, the system 100 may include any number of client devices 106. In addition, the client devices 106a . . . 106n may be the same or different types of computing systems.

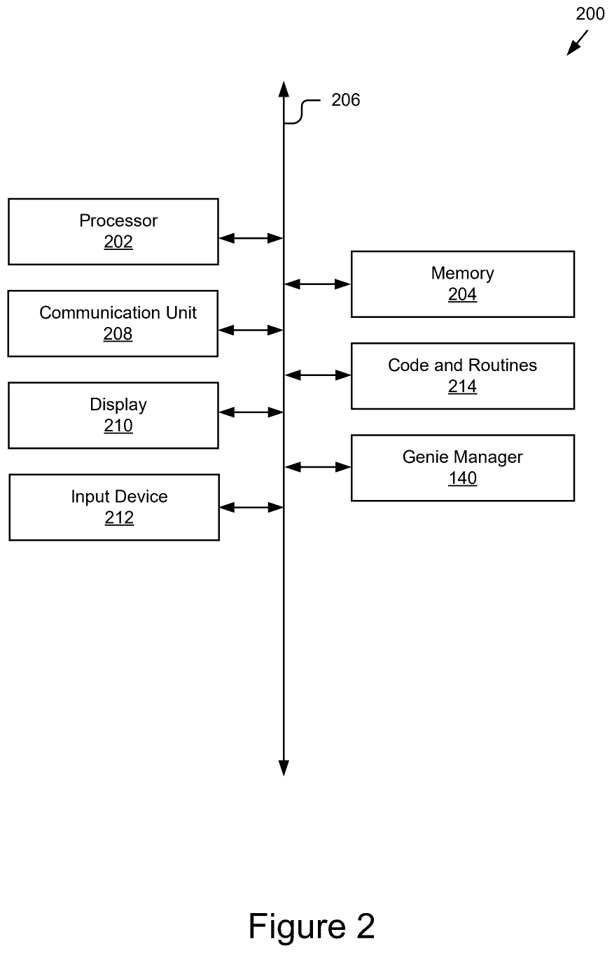

In the depicted implementation, the client devices 106a . . . 106n respectively contain instances 108a . . . 108n of a client application (also referred to individually and collectively as 108). The client application 108 may be storable in a memory (e.g., see FIG. 2) and executable by a processor (e.g., see FIG. 2) of a client device 106 to provide for user interaction, receive user input, present information to the user via a display (e.g., see FIG. 2), and send data to and receive data from the other entities of the system 100 via the network 102. Examples of various interfaces that can be rendered and presented by the client application 108 are depicted herein. In some implementations, the client application 108 may present or interact with a chat application or conversational interface operable on a third-party server (not shown) and/or on the server system 150.

In some implementations, the client application 108 may generate and present various user interfaces to perform these acts and/or functionality, such as the example graphical user interfaces discussed elsewhere herein, which may, in some cases, be based at least in part on information received from local storage, the server system 150, and/or one or more of the third-party applications 160 via the network 102. In some implementations, the client application 108 is code operable in a web browser, a native application (e.g., mobile app), a combination of both, etc. Additional structure, acts, and/or functionality of the client devices 106 and the client application 108 are described in further detail elsewhere in this document.

In some implementations, the client application 108 may include or communicate with the genie manager 140, as described in further detail below. For instance, the client application 108 may incorporate some or all of the functionality described in reference to the genie manager 140.

The server system 150, a third-party server (not shown), and/or the third-party applications 160 may include one or more computing systems having data processing, storing, and communication capabilities. For example, these entities 150 and/or 160 may include one or more hardware servers, virtual servers, server arrays, storage devices and/or systems, etc., and/or may be centralized or distributed/cloud based. In some implementations, these entities 150 and/or 160 may include one or more virtual servers, which operate in a host server environment and access the physical hardware of the host server including, for example, a processor, memory, storage, network interfaces, etc., via an abstraction layer (e.g., a virtual machine manager).

In the depicted implementation, the server system 150 includes a web server 120, a trigger event queue 126, databases 124 and 138, worker instances 128, and a genie manager 140. These components, and their sub-components, are coupled for electronic communication with one another, and/or the other elements of the system 100. In some instances, these components may communicate via direct electronic connections or via a public and/or private computer network, such as the network 102.

In some implementations, a worker instance 128 represents a worker compute node and may include more than one secure container 130a . . . 130n, as shown in FIG. 1. A container in the worker instance 128, at a given time, may run a recipe. A container may add trigger events to the trigger event queue 126 and (responsive to the trigger event being triggered) receive events from the trigger event queue 126. The event poller(s) 132a . . . 132n is/are software configured to poll for messages indicating the completion of a prior call so the secure container can proceed to the next step of the recipe (or to completion as the case may be). The server system 150 may utilize any suitable runtime environment and process queue/worker architecture, such as Heroku™.

The web server 120 includes computer logic executable by the processor 202 (see FIG. 2) to process content requests. The web server 120 may include an HTTP server, a REST (representational state transfer) service, or other suitable server type. The web server 120 may receive content requests (e.g., product search requests, HTTP requests, commands, etc.) from client devices 106, cooperate with the other components of the server system 150 (e.g., genie manager 140, worker instances 128, trigger event queue 126, etc.) to determine the content and or trigger processing, retrieve and incorporate data from the databases 124 and 138, format the content, and provide the content to the client devices 106. In some instances, the web server 120 may format the content using a web language and provide the content to a corresponding client application 108 for processing and/or rendering to the user for display. The web server 120 may be coupled to the databases 124 and 138 to store retrieve, and/or manipulate data stored therein.

In some implementations, the components 108, 120, 128, 126, and/or 140 may include computer logic storable in the memory 204 and executable by the processor 202, and/or implemented in hardware (e.g., ASIC, FPGA, ASSP, SoC, etc.), to provide their acts and/or functionality. For example, with reference also to FIG. 2, in some implementations, the client application 108, the web server 120, the worker instances 128, the trigger event queue 126, and/or the genie manager 140, and/or their sub-modules are sets of instructions executable by the processor 202 to provide their functionality. In some implementations, these components and/or their sub-components are stored in the memory 204 of the computing system 200 and are accessible and executable by the processor 202 to provide their functionality. In any of the foregoing implementations, these components and/or their sub-components may be adapted for cooperation and communication with the processor 202 and other components of the computing system 200.

The databases 124 and 138 are information sources for storing and providing access to data. Examples of the types of data stored by the databases 124 and 138 may include user and partner account information, codes representing the recipes, requirement tables associated with the codes, input and output schemas associated with the codes and/or applications, event data, metadata, objects associated with the applications, codes, and/or schemas, etc., and/or any of the other data discussed herein that is received, processed, stored, or provided by the integration management system 100. Recipes may be associated with a user's account.

The databases 124 and 138 may be included in the computing system 200 or in another computing system and/or storage system distinct from but coupled to or accessible by the computing system 200. The databases 124 and 138 can include one or more non-transitory computer-readable mediums for storing the data. In some implementations, the databases 124 and 138 may be incorporated with the memory 204 or may be distinct therefrom. In some implementations, the databases 124 and 138 may include a database management system (DBMS) operable on the computing system 200. For example, the DBMS could include a structured query language (SQL) DBMS, a NoSQL DBMS, various combinations thereof, etc. In some instances, the DBMS may store data in multi-dimensional tables comprised of rows and columns, and manipulate, i.e., insert, query, update and/or delete, rows of data using programmatic operations.

The third-party applications 160a . . . 160n, as depicted, may respectively expose APIs for accessing the functionality and data of the third-party applications 160a . . . 160n (also referred to individually and collectively as 160). An application 160 may include hardware (e.g., a server) configured to execute software, logic, and/or routines to provide various services (consumer, business, etc.), such as video, music and multimedia hosting, distribution, and sharing; email; social networking; blogging; micro-blogging; photo management; cloud-based data storage and sharing; ERM; CRM; financial services; surveys; marketing; analytics; a combination of one or more of the foregoing services; or any other service where users store, retrieve, collaborate, generate, consume, and/or share information.

In some implementations, the third-party applications 160 may include messaging services, artificial intelligence models, chat bots, or other services. For example, in some implementations, the third-party application 160 may include one or more artificial intelligence agents or large language models that receive textual or other inputs and, based on training, determine intent, generate outputs, etc. For instance, some large language models may include Llama™, Gemini™, ChatGPT™, Claude™ etc., that may be hosted on a first-party or third-party server. These or other models may be tuned using user or company specific data, such as previous code, workflows, recipes, etc., generated in a training and/or verification dataset.

In some implementations, the client application 108, the various components of the server system 150, the third-party applications 160, etc., may require users 112 to be registered to access the acts and/or functionality provided by them. For example, to access various acts and/or functionality provided by these components, the components may require a user 112 to authenticate his/her identity (e.g., by confirming a valid electronic address or other information). In some instances, these entities 108, 120, 140, 160, etc., may interact with a federated identity server (not shown) to register/authenticate users 112. Once registered, these entities may require a user 112 seeking access to authenticate by inputting credentials in an associated user interface.

The system 100 illustrated in FIG. 1 may be representative of an example system for collaborative design, and it should be understood that a variety of different system environments and configurations are contemplated and are within the scope of the present disclosure. For instance, various functionality may be moved from a server to a client, or vice versa and some implementations may include additional or fewer computing systems, services, and/or networks, and may implement various functionality client or server-side. Further, various entities of the system 100 may be integrated into a single computing device or system or additional computing devices or systems, etc.

Additional acts, structure, and/or functionality of at least the client devices 106, the server system 150, the third-party applications 160, and their constituent components are described in further detail below.

FIG. 2 is a block diagram of an example computing system 200. The example computing system 200 may represent the computer architecture of a client device 106, a server system 150, a server of a conversational interface application, a server or computing device of a genie manager 140, and/or a server of the third-party application 160, depending on the implementation. As depicted, the computing system 200 may include a processor 202, a memory 204, a communication unit 208, a display 210, and an input device 212, which may be communicatively coupled by a communications bus 206. The computing system 200 depicted in FIG. 2 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc.

The processor 202 may execute software instructions by performing various input/output, logical, and/or mathematical operations. The processor 202 may have various computing architectures to process data signals including, for example, a complex instruction set computer (CISC) architecture, a reduced instruction set computer (RISC) architecture, and/or an architecture implementing a combination of instruction sets. The processor 202 may be physical and/or virtual and may include a single core or plurality of processing units and/or cores. In some implementations, the processor 202 may be capable of generating and providing electronic display signals to a display device, supporting the display of images, capturing and transmitting images, performing complex tasks including various types of feature extraction and sampling, etc. In some implementations, the processor 202 may be coupled to the memory 204 via the bus 206 to access data and instructions therefrom and store data therein. The bus 206 may couple the processor 202 to the other components of the computing system 200 including, for example, the memory 204, the communication unit 208, display 210, and the input device 212. For instance, the processor 202 may include one or more central processing units, graphics processing units, neural processing units, etc.

The memory 204 may store and provide access to data to the other components of the computing system 200. The memory 204 may be included in a single computing device or a plurality of computing devices as discussed elsewhere herein. In some implementations, the memory 204 may store instructions and/or data that may be executed by the processor 202. For example, the memory 204 may include various different combinations of the software components described herein, depending on the configuration. The memory 204 is also capable of storing other instructions and data, including, for example, an operating system, hardware drivers, other software applications, databases, etc. The memory 204 may be coupled to the bus 206 for communication with the processor 202 and the various other components of computing system 200.

The memory 204 includes a non-transitory computer-usable (e.g., readable, writeable, etc.) medium, which can be any tangible apparatus or device that can contain, store, communicate, propagate or transport instructions, data, computer programs, software, code, routines, etc., for processing by or in connection with the processor 202. In some implementations, the memory 204 may include one or more of volatile memory and non-volatile memory. For example, the memory 204 may include, but is not limited, to one or more of a dynamic random access memory (DRAM) device, a static random access memory (SRAM) device, a discrete memory device (e.g., a PROM, FPROM, ROM), a hard disk drive, an optical disk drive (CD, DVD, Blue-ray™, etc.). It should be understood that the memory 204 may be a single device or may include multiple types of devices and configurations.

The bus 206 can include a communication bus for transferring data between components of a computing system or between computing systems, a network bus system including the network 102 and/or portions thereof, a processor mesh, a combination thereof, etc. In some implementations, the various components of the system 100 may cooperate and communicate via a software communication mechanism implemented in association with the bus 206. The software communication mechanism can include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The communication unit 208 may include one or more interface devices (I/F) for wired and/or wireless connectivity with the network 102 and/or other computing systems. For instance, the communication unit 208 may include, but is not limited to, CAT-type interfaces; wireless transceivers for sending and receiving signals using Wi-Fi™, Bluetooth®, IrDA™, Z-Wave™, ZigBee©, cellular communications, and the like, etc.; USB interfaces; various combinations thereof; etc. The communication unit 208 may connect to and send/receive data via a mobile network, a public IP network of the network 102, a private IP network of the network 102 etc. In some implementations, the communication unit 208 can link the processor 202 to the network 102, which may in turn be coupled to other processing systems. The communication unit 208 can provide other connections to the network 102 and to other entities of the system 100 using various standard network communication protocols, including, for example, those discussed elsewhere herein.

The display 210 may display electronic images and data output by the computing system 200 for presentation to a user 112. The display 210 may include any conventional display device, monitor or screen, including, for example, an organic light-emitting diode (OLED) display, a liquid crystal display (LCD), etc. In some implementations, the display 210 may be a touchscreen display capable of receiving input from one or more fingers of a user 112. For example, the display 210 may be a capacitive touchscreen display capable of detecting and interpreting multiple points of contact with the display surface. In some implementations, the computing system 200 may include a graphics adapter (not shown) for rendering and outputting the images and data for presentation on display 210. The graphics adapter (not shown) may be a separate processing device including a separate processor and memory (not shown) or may be integrated with the processor 202 and memory 204.

The input device 212 may include any device for inputting information into the computing system 200. In some implementations, the input device 212 may include one or more peripheral devices. For example, the input device 212 may include a keyboard (e.g., a QWERTY keyboard), a pointing device (e.g., a mouse or touchpad), microphone, an image/video capture device (e.g., camera), etc. In some implementations, the input device 212 may include a touchscreen display capable of receiving input from the one or more fingers of the user. For instance, the structure and/or functionality of the input device 212 and the display 210 may be integrated, and a user of the computing system 200 may interact with the computing system 200 by contacting a surface of the display 210 using one or more fingers. In this example, the user could interact with an emulated (i.e., virtual or soft) keyboard displayed on the touchscreen display 210 by using fingers to contact the display in the keyboard regions.

A workflow or recipe may be an integration flow that contains a trigger and a set of actions. The trigger causes the actions in a recipe to be executed. Actions are the routines the recipe runs. Each action may include an input configuration and is associated with a given application (e.g., a third-party application 160). Each trigger and action may further include metadata, such as an input schema and an output schema. Actions may run in parallel, series, or various combinations thereof. In some instances, one action may be dependent upon the output of a preceding action. In a typical recipe configuration, the different actions in the recipe are associated with different applications, and the recipe automates the interaction between the different applications using the application programming interfaces (APIs) of those applications. For instance, the recipe may flow, sync, etc., data from one application to another, populate multiple different applications with data from a source application, etc. In some implementations, the recipes are written in Ruby, and the secure containers 130 of the worker instances 128 interpret and process the recipes, although it should be understood that other languages and interpreters may be used. In some cases, a workflow may include one or more recipes, for example.

In some implementations, one or more modules or engines, such as a genie manager 140, code and routines 214, or components may be included in and/or may include computer logic storable in the memory 204 and executable by the processor 202, and/or implemented in hardware to provide its acts and/or functionality, such as the description herein. Other code and routines 214 may be used to provide other communication and functionality of the computing device 200. For instance, a genie manager 140 may be machine learning or large language model or a decision or logic-based application that may provide or interact with a user via a chat or other user interface, for example, where a user may ask an AI assistant to do something within a platform.

In some implementations, a genie manager 140 may include or may interface with an AI assistant. For instance, a genie manager 140 may alternatively be referred to herein as an AI assistant, but it may interface with one or more AI assistants, or large language models, etc., to provide functionality.

Along with the other figures herein, the figures illustrate example implementations and features of a platform that provides various benefits, as described in detail herein. It should be noted that, although certain examples are provided, others are possible and contemplated.

The framework supports iteratively asking an AI system for the next process step to execute. Each step can interact with systems and applications based on a selection, the AI makes from a set of available tasks, and the output from those, as well as any user input, may be used to guide further step generation, with the AI also determining when sufficient steps have been done to fulfill the requested task. In this context, as noted elsewhere herein, AI here could be a general-purpose generative AI system or another type of machine learning. Although some examples are provided, the system does not require a particular type of system or a specific AI vendor. Some further capabilities connected with this may include running the process within a particular context, adding an interactive component, and/or using multiple interactive agents.

An example capability includes running the process within a context that describes the goals of the system, the third-party systems and internal tasks available, previous interaction history, and one or more user identities usable for external systems access. The latter feature may provide that the process does not provide any data outside the calling user's permission set. Certain genies may be granted the permission to act “on behalf of” specific users, using credentials obtained from a secure datastore. Contexts may include multiple hierarchical scopes (e.g., user, team, company).

An example capability includes adding an interactive component so that performing certain third-party actions can be contingent upon end-user approval, such as those operations described elsewhere herein. It should be noted that other kinds of interactivity are possible, such as where a user suggests a next step or decides to terminate/continue step generation. The decision to seek approval can itself, as noted elsewhere herein, be AI-determined, for example by generating and using a confidence score for the correctness of a proposed step.

An example capability includes a higher-level system that can be composed out of multiple interactive agents, each with its own context. An example may include using an initial bot to determine the user's intent or do preliminary diagnosis on a problem and then calling a secondary more domain-specific agent. This sequence may not be predetermined, but the number and sequence of agents called can be AI-generated.

Another distinguishing feature of the platform described herein may include scenarios involving dynamic business process generation. As noted elsewhere herein, tasks may be or include recipes, which can implement complex processes. Because recipes may have a JSON (Java Script Object Notation) representation, those tasks may be dynamically generated, including generation by an AI system. This implementation may support the concept of a “process agent” or “agent-building agent.” For instance, an agent-building agent may be an agent that can generate new processes and provide access to those via APIs to genies.

In some implementations, the process agent can receive a text description of goals. Based on the text description, it may generate a new process, genie, module, tool, etc., and it may expose an API to clients within the genie manager 140 ecosystem.

In some implementations, the generation process may be modified or subject to approval based on human feedback.

In some implementations, the system may provide task generation “by example:” from observation of past interactions, the system can propose and generate the outline of a new process to perform a commonly used sequence of steps, including both a workflow component and a proposed user interface (e.g., for approvals). This can increase runtime efficiency by replacing repetitive steps previously generated by calls to the AI system with a fixed process that does the same steps but does not require AI interaction at runtime. For instance, the system may perform these operations in the method 500 below, such as where an AI chatbot interacts with a user to add modules, configure modules, configure tools, or otherwise based on prompts, user data/context, and/or past interactions.

In some implementations, the AI system may test a generated process within a sandbox environment (using the test capabilities of the platform or a service) and based on the results, correct or refine the generated code.

For example, the platform may use AI (e.g., LLM or large language model) based experiments with automated processes, such as where an LLM prepares data for an experiment; the LLM orchestrates execution of two versions of the source code, compares outputs and calculates metrics; and/or the LLM provides a report with metrics comparison, guides or implements selection of the better process version.

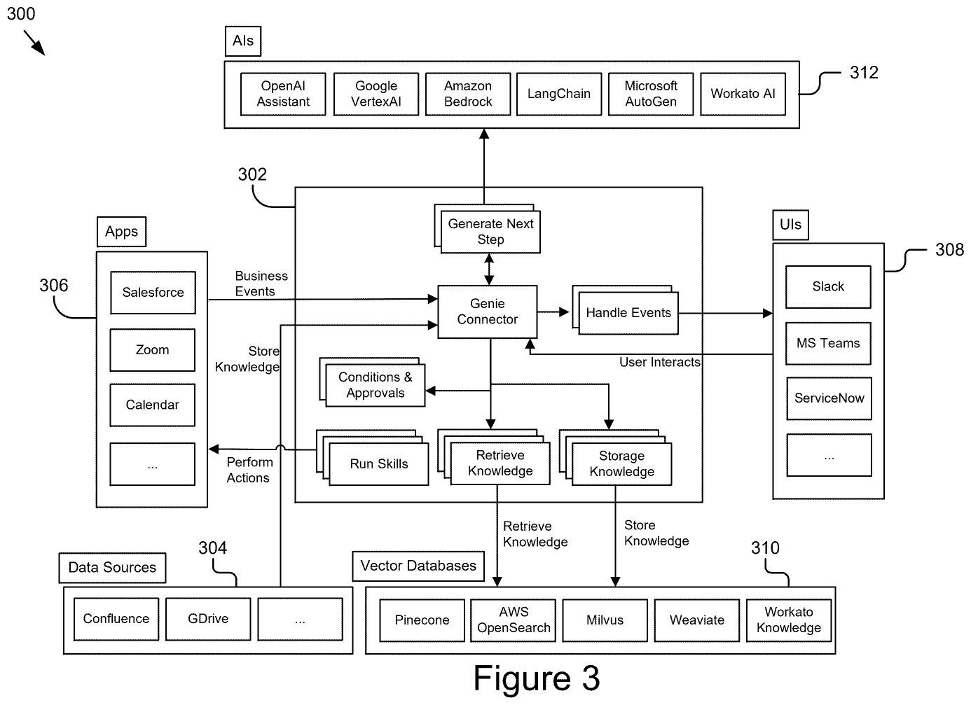

FIG. 3 is a block diagram illustrating an example architecture 300 and data flow for providing a framework and set of tools for constructing AI-guided interactive agents. For instance, the example architecture 300 and data flow provides a genie manager 140 and/or its functionality. For example, a genie manager 140 may include a general-purpose platform for rapidly constructing interactive agents (“genies”) that perform and assist in business functions. Such agents may make use of capabilities from chat or other user interaction platforms, applications and software-implemented processes, and artificial intelligence (AI) systems. The genie manager 140 may include an authoring environment, a runtime execution environment, and an underlying software framework.

The extensible and/or modular software framework may support construction and reuse of modular components (referred to as modules and tasks herein) that may be used across one or multiple genies. In some implementations, these components may be invoked under the direction and coordination of an AI system. Tasks may be internally complex, for instance, they may be entire processes in themselves, involving multiple steps, possibly iterative, and entailing connection to multiple external systems. These processes may be constructed manually or produced by an AI, which also may help determine the need for a new process.

The authoring environment may include a no-code/low-code environment accessible to non-technical users. For instance, a user may drag or otherwise select modules into an interface to piece together a process or skillset for an interactive agent. The interface may provide graphical elements that allow the configuration to be made without the user having to perform much if any coding. Similarly, as described elsewhere herein, the user may interact with an AI chatbot, which considers tasks to be accomplished and modules and tools for those tasks in order to accomplish the goal designated by the user. Accordingly, the AI chatbot may take a job description, consider skills or modules and knowledge bases, and link them together. Similarly, an AI chatbot may test, evaluate, provide suggested improvements, or execute other tasks for an interaction agent.

In some implementations, a module may be selected and included with an interaction agent, where the module provides analytics and/or tracking for the agent. Accordingly, metrics for the agent may be provided to a graphical dashboard for the user, organization, or otherwise.

The runtime environment may include a flexible, high-performance, asynchronous task execution system. It may maintain a context during execution, including a user identity that may be used when connecting to various systems.

The overall system supports a number of dynamic execution scenarios, such as having the system receive an input, and in response iteratively execute AI-driven steps that interact with systems and applications, progressing towards a defined goal or task.

The system may support replaceable components, including user interfaces, AI systems, and connected business applications and/or processes. It may also support a wide variety of interaction scenarios, which flexibility provides significant advantages over previous systems. In some implementations, the overall system may build upon features of a platform (e.g., Workato™) with previous development, and which may provide capabilities, such as user interface components and features facilitating ease of use, a framework for building and running automations (e.g., recipes), and a system for abstracting and making available application connectivity (connectors).

The interactive agents (“genies”) constructed using the example architecture of FIG. 3, may perform and assist in business functions, and it may leverage AI capabilities, for example, by exposing a rapid no-code development environment for such genies to a user.

Each genie may have a set of capabilities available to it that it can call upon to perform a task. For instance, these may include: a chat application such as Slack™ for a user interface; an AI provider for text processing, inference and generation; and the ability to automatically source data from business applications to which the genie is granted access. In some implementations, genies may support other types of interaction models (e.g., a “headless” genie invocable via an API). In some cases, this architecture may provide a safe execution model that does not allow users to exceed their assigned permissions in applications.

The genie manager 140 may use features, such as connectors (e.g., for connecting with an application or service), recipes (e.g., for providing workflow/task execution), and a workbot (e.g., a chat interface that may provide chat integration).

Genies may be used in isolation, or they may form part of an evolving ecosystem that includes multiple interacting genies coordinating to perform an overall task. This coordination can be orchestrated by an AI system.

The functions, interactions, and capabilities of genies may be static or may be able to dynamically evolve over time, supporting continuous improvement and allowing new and extended business use cases to be addressed. Examples of dynamic evolution can include learning from past behavior and inputs, incorporating new data sources over time, modifying the schemas or capabilities of existing data sources, dynamically choosing execution paths based on context, etc.

For example, some terms used herein may be defined as follows, though other uses, or plain meetings may be used, these are provided to improve readability. Genie: A specialized digital assistant (agent) designed to perform domain-specific tasks based on custom instructions and domain expertise. Skillset: An independent unit of functionality related to a particular domain, application, or system. Modules can be combined to form genies, promoting reusability and modularity across different applications. Skill: Configured within a module, a tool may have a specific input/output schema and can require runtime user connections. Approval Condition: Custom logic that evaluates tool call parameters to determine if the action should proceed, require approval, or stop. Approval Flow: Facilitates user approvals through various methods (e.g., button clicks, text confirmations) and allows parameter modifications. It should be noted that although example definitions are provided for these terms, other implementations are possible and contemplated herein.

In some implementations, genie manager 140 capabilities may be packaged and made available in the form of a platform connector, which may include a tool that facilitates the orchestration and execution of AI-driven processes. Users can define and manage various components such as genies, modules, tools, approval conditions, and approval providers. These components may work together to form a flexible and dynamic framework for building low or no-code AI applications.

As illustrated in FIG. 3, the platform may employ an asynchronous events architecture, allowing different systems and components to interact and operate independently. This design enhances scalability, flexibility, and responsiveness, ensuring a robust and efficient environment, for example, for building and deploying low/no-code applications.

As noted elsewhere herein, a genie may include a purpose-built digital assistant designed to perform specific tasks based on custom instructions, a defined set of tools, and domain-specific knowledge. Genies may provide functionality within the platform and may be capable of leveraging various modules to accomplish their tasks.

Depending on the implementation, a genie may include one or more modules, which may be independent units of functionality, each related to a specific domain, application, or system. The modules may provide the tools and operations used for a genie to perform its tasks. In some instances, when creating a genie, users can configure each module with specific parameters to tailor the genie's behavior to their needs. This may include defining which tools are available, setting approval rules, and configuring knowledge retrieval processes.

Modules may be self-contained units of functionality that can be combined to form genies. They may abstract the underlying system, allowing genies to operate independently of any specific application or service.

While other implementations are possible and contemplated, example modules may have various types, such as those described in further detail here and elsewhere herein. UI Modules: Facilitate interaction between the genie and the end-user. They may handle user inputs, display messages, and manage approval processes. Tool Group Modules: Group functionally similar tools together, allowing for reuse across different genies. They may provide a standardized interface for tools, making them interchangeable. AI Modules: Integrate interactive agent services with the genie. They may handle the communication between the genie and AI services, including tool calls, knowledge retrieval, and message processing. Knowledge Modules: Provide storage and retrieval of domain-specific knowledge. They may enhance the genie's capabilities by enabling access to relevant information during its operations.

In some implementations, the architecture for a genie manager 140, such as is illustrated in the example of FIG. 3 may include various tools, which may include specific functions or operations defined within the context of a module. These may provide application access, and/or they may be mediated through an interface that may not match the native application interface directly. They may be configured with input/output schemas and can require runtime user connections.

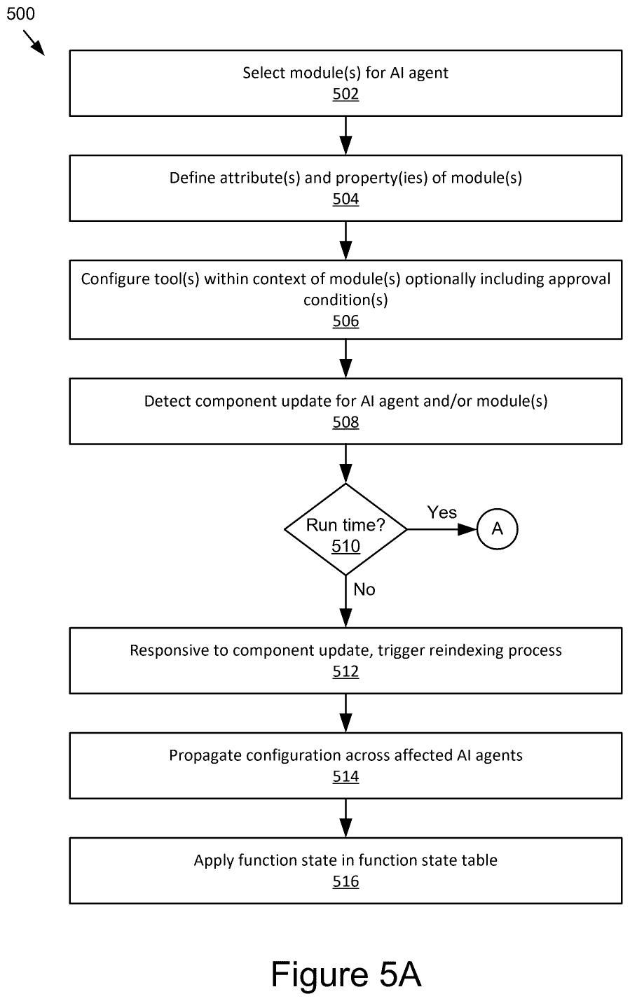

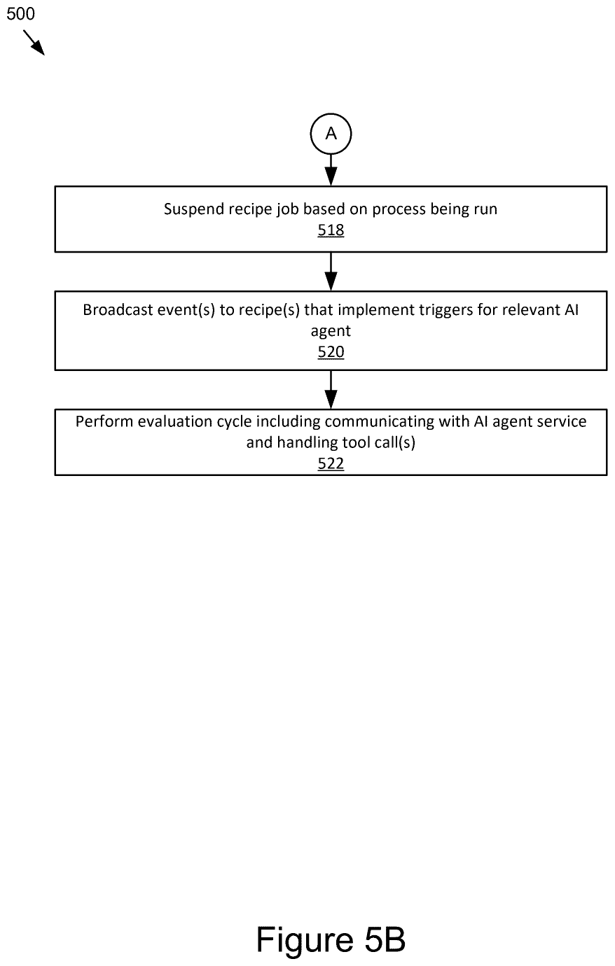

As illustrated in FIG. 3 and described elsewhere herein, the technology may use an asynchronous events architecture to decouple various systems and components. This design allows for independent operation and interaction of components, enhancing scalability, flexibility, and responsiveness. As an example, this may be split into one or more design time processes and one or more run time processes. Further details are described below, for example, in reference to FIGS. 5A-5B.

An illustrative lifecycle of a tool call is provided in further detail herein, such as through initiation, connections, approval, and execution, although other implementations are possible and contemplated herein.

In some implementations, tool calls may be initiated by the AI with dynamic parameters. These parameters can include user inputs, contextual data from the process, or predefined configurations set during the design phase.

In some implementations, tools may require user-specific credentials (e.g., user-scoped connections) to execute. The system facilitates obtaining these credentials through a runtime user connection architecture that provides secure handling of user data.

In some implementations, before a tool call proceeds, approval conditions are evaluated for approval rules. These rules are defined within the module and can include custom logic to check the parameters of the intended tool call. The custom logic evaluates whether the AI or the end-user should be allowed to call the tool, as noted in the following example approval conditions. For instance, the possible outcomes may include: Continue: The tool call proceeds without further action. Require Approval: The tool call is configured to require approval from designated users. Stop: The tool call is halted.

In some instances, the approval rules may specify approval by a provider, for example, it may facilitate getting approval from designated users. This can be through a button click, text confirmation, or other forms of approval. The possible outcomes may include: Approve: The tool call proceeds. Reject: The tool call is halted. Approve with Updated Parameters: Users can modify the parameters before the tool call proceeds. These and other operations are described in further detail in reference to the other figures herein.

In some implementations, once approved, the tool call may be executed using the provided parameters and/or user credentials. The results may then be processed and passed back to the AI for further evaluation and action.

As illustrated in FIG. 3, example configurations and components of a system 300 are shown, although others are possible. As shown in the example, a genie manager 140 server 302 may be communicatively coupled with various other systems to receive data therefrom or send data thereto. The genie manager 140 server 302 may include various components or modules that provide functionality described herein.

For instance, as shown, the genie manager 140 server 302 may a genie connector that receives information from (and/or stores data to) data sources 304, such as Confluence™, Google Drive™, or otherwise. The genie connector may receive data from one or more third-party servers or applications 306, for example, which serve as inputs or triggers to modules or tools. Example applications may be any application or system that the genie manager 140 or AI model has access to in order to achieve a defined task. While Salesforce™, Zoom™, and calendar are shown, other implementations are possible and contemplated. The genie connector may also provide handle events or other outputs to various user interfaces 308 and/or receive user interactions from the user interface(s) 308. Accordingly, the user interfaces (e.g., Slack™, Microsoft Teams™, ServiceNow™, etc.) may allow a user to ask questions, instruct an AI to perform tasks, approve tool calls, or monitor AI driven processes.

The genie connector(s) may be communicatively coupled with various other internal and external systems or services. In some cases, genie manager 140 may evaluate conditions and approvals, execute skills (e.g., by communicating with application 306, data sources, etc.), or perform other operations. The genie manager 140 may retrieve data from or store data to one or more databases 310, such as vector databases. Some example databases that may be integrated or used with a genie (e.g., via a module, tool, or otherwise) include Pinecone™, AWS OpenSearch™, Milvus™, Weaviate™, or Workato Knowledge™.

In some implementations, the genie manager 140 may have integrated or communicatively coupled various AI models or services 312, which may generate a next step, execute tasks of modules, provide inputs or outputs, or otherwise, as noted in the examples herein. For instance, a prompt or system prompt may be provided (e.g., “You are the Assistant to XYZ. Please follow these steps to <insert goal> . . . ”). The AI tools may include conversational agents that provide interaction, provide coding or piece together coding components or modules, build assistants or agents, provide generative AI applications, or otherwise. Various examples of AI services that may be used include OpenAI Assistant™, Google VertexAI™, Amazon Bedrock™, LangChain™, Microsoft AutoGen™, or Workato AI™.

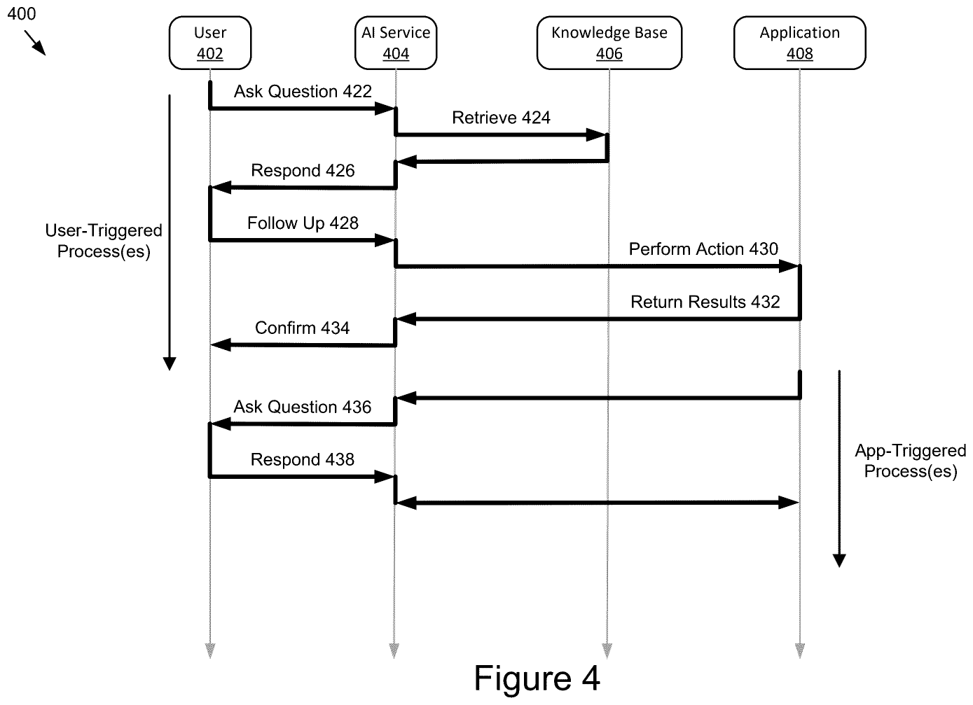

FIG. 4 illustrates an example process 400, which may represent an aspect of a lifecycle of a process run, although other implementations are possible and contemplated herein.

When initiating a process, contextual inputs and external IDs may be provided to ensure the genie has all necessary information to execute its tasks. These inputs help maintain the logical thread of the process across different systems and events.

The following order of events are provided for an example process run, but other events, operations, orders, etc., are possible. Additional features and details are described elsewhere herein. 1. Process Started/Resumed: The process may be initiated or resumed, and the event may be used to notify UI modules to start the conversation with the end-user and set initial process attributes. 2. Step Added/Updated: Triggered when a new message is added, a tool call may be initiated or completed, or a knowledge retrieval may be started or finished. This event may update the UI module and other relevant systems with the latest process details. 3. User-Scoped Connection Required: If a tool requires user-specific credentials, this event may facilitate obtaining the necessary credentials from the user to execute the tool call. 4. Approval Condition: When an approval rule is defined, this event may be triggered to evaluate the approval condition before proceeding with the tool call. 5. Approve Tool Call: Triggered when an approval rule condition returns a status of “requires approval,” this event may manage the approval process with designated users. 6. Error: If an unexpected error occurs during any part of the process, this event may be triggered to handle the error, provide notifications, and possibly initiate recovery actions. 7. Process Stopped: Triggered when the process completes its execution. This event may be used for cleanup steps and final notifications. 8. Process Deleted: When a thread or process is deleted, this event may handle cleanup steps and ensure related data and resources are properly disposed.

As shown in FIG. 4, various example signals are illustrated among a user 402, AI service 404, knowledge base 406, and business application 408. Some of the signals may be user-triggered processes while others may be application-triggered processes.

In the depicted example, a user 402 may ask a question 422 of an AI service 404 (e.g., an AI model or an Interactive agent), which may retrieve 424 data to respond to the question from a knowledge base 406 (e.g., using retrieval augmented generation or other methods). The AI service 404 may respond 426 to the user, for example, via a chat interface. In some cases, the user 402 may ask a follow-up question 428 of the AI service 404. In some implementations, the AI service 404 may perform an action 430 using an application 408, such as using a module or tool, as noted elsewhere herein. The application 408 may execute the action and, potentially, return the results 432 to the AI service 404, which may confirm 434 the results to the user 402.

In some cases, an application 408 may trigger the communication, for example, based on an event or other data generated at the application 408. For example, the application 408 may transmit a message to the AI service 404, which may ask a question 436 of the user, such as a clarifying question, a question about generating a genie, module, tool, or performing another operation, such as those described elsewhere herein. The user 402 may respond 438 to the AI service 404, which may relay the information to the application 408, for example, for further processing.

FIGS. 5A-5B illustrate a flowchart of an example method 500 for providing AI connections, such as where various components, such as genies/agents, modules, tools, approval conditions, and approval providers work together to form a flexible and dynamic framework for building no-code or low code AI applications. For instance, the method 500 may allow an AI guided interactive agent to be provisioned and/or updated. It should be noted that the operations and features described in reference to FIGS. 5A-5B may be modified, rearranged, reduced, or augmented, and that the other operations and features described herein may provide additional detail, may be used with those of the method 500, or may be used in place of those of the method 500. Furthermore, the operations of the method 500 are described as being performed by a genie manager 140, it may be fully or partially (e.g., in conjunction with the genie manager 140) performed by another component or system.

In some implementations, the genie manager 140 may allow a user to define an interactive agent that performs domain-specific tasks. The interactive agent may be generated or provisioned to perform one or multiple defined tasks using one or more tools. Accordingly, the genie manager 140 or a user using the genie manager 140 may initiate generation of an interactive agent to perform a defined task.

An AI Agent may include a specialized digital assistant designed to perform domain-specific tasks based on custom instructions and domain expertise. For example, an interactive agent may include at least one module, which provides a tool for performing a task.

In some cases, the interactive agent or genie may set up in an authoring environment in which capabilities are packaged into tool, modules, etc., as described herein. interactive agent capabilities may be packaged and made available to users in the form of a platform connector, which may be tool that facilitates the orchestration and execution of AI-driven processes. Users can define and manage various components such as genies, modules, tools, approval conditions, and approval providers. These components work together to form a flexible and dynamic framework for building no-code AI applications.

A genie or interactive agent may be a purpose-built digital assistant designed to perform specific tasks based on custom instructions, a defined set of tools, and domain-specific knowledge. The interactive agent may be a unit of functionality within the platform, which is capable of leveraging various modules to accomplish their tasks.

In some implementations, at 502, the genie manager 140 may select one or more modules for an interactive agent. For instance, determining the at least one module for the interactive agent may include selecting the at least one module from among a set of available modules. The modules may be listed by the tasks that they perform, their tools, approval rules, knowledge bases, etc. A module may include a skillset, such that it includes an independent unit of functionality related to a particular domain, application, or system. Modules may be combined to form interactive agents or genies, which provides reusability and modularity across different applications. A module provides the tool for an interactive agent to perform its tasks. As noted below, a module may include a skill and/or tool with a specific input/output schema and can require runtime user connections.

A module may abstract the underlying system, which allows interactive agents to operate independently of any specific application or service. As noted elsewhere herein, a module may be selected from among various module types, such as UI modules, tool group modules, AI modules, or knowledge modules. A UI module may facilitate interaction between the interactive agent and the end-user, and it may handle user inputs, display messages, and managed approval processes. A tool group module may group functionally similar tools together, allowing for reuse across different genies, and it may provide a standardized interface for tools thereby making them interchangeable. An AI module may integrate interactive agent services with a genie, for example, it may handle the communication between the genie and AI services, including tool calls, knowledge retrieval, and message processing. A knowledge module may provide storage and retrieval of domain-specific knowledge, and it may enhance a genie's capabilities by enabling access to relevant information during its operations.

In some implementations, at 504, the genie manager 140 may define (e.g., based on user input) one or more attributes and/or properties of the module(s). For instance, when creating a genie, users can configure each module with specific parameters to tailor the genie's behavior to their needs. Configuring a module may include defining which tools are available, setting approval rules, and configuring knowledge retrieval processes, for instance. Accordingly, not only can an interactive agent or genie be provisioned with modular modules having functionality, but the modules can also be configured for the user's specific circumstances. A module may also be configured with various properties, such as name, defaults, dependency orders, etc.

For example, either by selecting the module or defining its attributes, the interactive agent may be configured to retrieve from and store data to one or more third-party databases associated with a domain-specific task. In some instances, the interactive agent may be configured to receive event data from one or more third-party servers. It may be configured to receive user input via a chat prompt, identify the task based on the chat prompt, and perform one or more tool calls to perform the task. Various tasks may be defined based on the tools, as discussed elsewhere herein. Furthermore, the tasks may include multi-step processes, such as interfacing with one or more second interactive agents, genies, AI models, or otherwise to perform the task.

Various attributes may be used, such as configuration attributes, genie/interactive agent attributes, or process attributes. Configuration attributes may include metadata set by the builder during the module's design time, and they may customize the module's behavior within a specific Genie. Genie attributes may include metadata relevant to the contract between the genie and the module, and they may be used internally by the platform to manage interactions and configurations. Process attributes may include metadata used during the process run of a genie, and they may include user information, thread IDs, and other ephemeral data relevant to the current process.

Similarly, modules may have various properties, such as the following. Name: each module may be given a unique name. Attributes: define any of the types of attributes (configuration, genie, process). Configuration defaults: set defaults, if applicable. Dependencies: handled by the order of addition to the genie.

In some implementations, at 506, the genie manager 140 may configure one or more tools (e.g., based on user input) within the context of the one or more modules, for example, this may optionally include configuring approval conditions. Tools are specific functions or operations defined within the context of a module, and they may provide application access, which may be mediated through an interface that may not match the native application interface directly. In some cases, periodically, at the beginning of configuration, or at an update, the genie manager 140 may index parameters of a tool. They may be configured with input/output schemas for connecting with a service and can be configured to require runtime user connections. Accordingly, a tool may perform a task or sub task of the module and/or genie.

In some implementations, tools may be integrated into interactive agents/genies through modules, so that when a module is added to a genie, the tools within that module become available for the genie to use. During the configuration of a genie, builders can select which tools from the module will be active and how they will be parameterized for the specific genie.

Tool calls may involve multiple systems, conditional statements, and custom logic, which may be exposed to modules as a single call, which provide tool calls.

A tool may have various configurations and characteristics, such as a contextual definition, input/output schema, custom logic, user-scoped connections, or otherwise. For a contextual definition, tools may be defined within the context of a module, and each tool may have a specific purpose and operates based on the parameters and configurations set during the design phase. For input/output schema, tools may be configured with a specific input and output schema, ensuring that they can process data correctly and return the expected results, and the schema may define the structure of the data that the tool will receive and produce. For custom logic, tools may contain complex logic, allowing builders to create sophisticated operations involving multiple systems and conditional statements, which capability may enable builders to maintain control over the execution consistency and outcomes of tool calls. For user-scoped connections, tools may be configured to require runtime user connections, which means that certain tools may use user-specific credentials to execute, ensuring that actions are performed with the appropriate permissions and access levels.

As noted elsewhere herein, in some implementations, because a tool may interface with another system, application, or process, or because the tool may perform sensitive operations, the tool may be configured with one or more approval rules and associated conditions that require higher level (e.g., by a user executing the process) approval or other determinations conditions for approving or authorizing the process before it proceeds. Similarly, in some cases, the approval rule may define that certain credentials are entered and/or used as part of the tool call.

In some implementations, once a tool is configured, a user may proceed to another tool or to another module for the interactive agent to provide its configuration.

In some implementations, the interactive agent may be initiated or otherwise used, such as described elsewhere in this application and in reference to the example FIG. 4. For example, the process may be initiated to perform a defined task using the interactive agent. In some cases, this operation may involve the interactive agent receiving an AI prompt and executing a tool call using a tool based on the AI prompt.

In some implementations, at 508, the genie manager 140 may detect a component update for the interactive agent and/or module(s). For instance, the technology may use an asynchronous events architecture to decouple various systems and components. This design allows for independent operation and interaction of components, enhancing scalability, flexibility, and responsiveness, among other potential benefits. The detected update may be based on a received notification, a manual configuration, a periodic check, a push notification, etc.

Depending on the case, the genie manager 140 may use a design time process or a run time process, which may be based on how the interactive agent, modules, tools, or updates are configured. At 510, the interactive agent may determine whether an update is a run time update or a design time update. If the process is run time, the method 500 may proceed to 518. If the process is design time, the method 500 may proceed to 512.

For a design-time update and based on the component update, the genie manager 140 may trigger a reindexing process at 512. For example, when a component is updated (e.g., a tool's parameters change), the system triggers a reindexing process, which provides that all interactive agents/genies are aware of the latest configuration. The genie definition may then be re-executed to incorporate the updates.

In some implementations, at 514, the genie manager 140 may propagate the configuration across genies/interactive agents. For example, during the reindexing process, the genie manager 140 may suspend the genie definition, execute the updated module recipe, and the resume the genie definition. These operations provide that the updates are applied consistently across all affected genies, maintaining the integrity of the configuration.

In some implementations, at 516, the genie manager 140 may apply a function state in a function state table. For example, the system may use a function state table to manage the state of each function and avoid collisions when multiple updates occur simultaneously. The function state may thereby be applied in a controlled manner to ensure that no updates overwrite others, preserving the consistency of the genie configuration. This process may also be used during initial configuration, etc.

For a run-time update and based on the component update, the genie manager 140 may suspend a recipe job based on a process being run at 518. For example, depending on the implementation, a recipe job may call an interactive agent, module, tool, and/or may be called therefrom. A module or tool thereof may include or consist of a recipe, which receives triggers and, in response, executes certain operations.

In some implementations, at 520, the genie manager 140 may broadcast one or more events to one or more recipes that implement triggers for relevant interactive agents. For example, events may be broadcasted to all recipes that implement triggers for those events in the modules added to the relevant genie, which decouples the interactive agent service from the genie and the applications it uses to handle those events.

In some implementations, at 522, the genie manager 140 may perform an evaluation cycle including communicating with an interactive agent service and handling one or more tool calls. For example, the evaluation cycle may involve sending messages to the interactive agent service, waiting for status, handling tool calls and knowledge retrieval, and managing user interactions and approvals. This process may include executing the interactive agent as noted in further detail elsewhere herein.

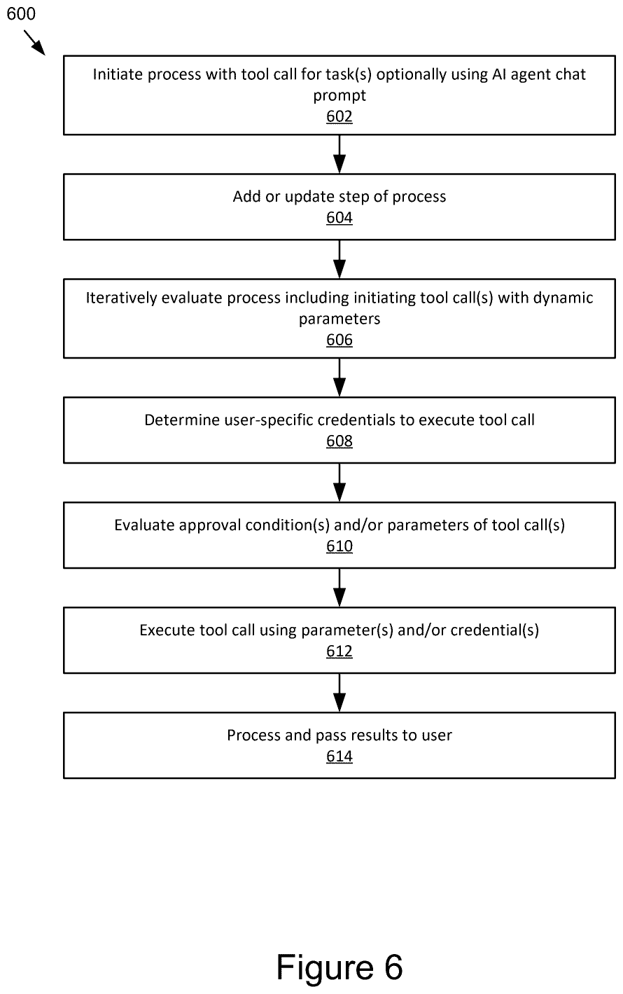

FIG. 6 illustrates a flowchart of an example method 600 for using an AI-guided interactive agent. As noted above, while the example method 600 is described as being performed by the genie manager 140, its operations and features may be performed directly by an executable interactive agent or another component. It should be noted that the operations and features described in reference to the figures may be modified, rearranged, reduced, or augmented, and that the other operations and features described herein may provide additional detail, may be used with those of the method 600, or may be used in place of those of the method 600.

In some implementations, at 602, the genie manager 140 may initiate a process associated with the genie, one of its modules, and/or one of its tools. For example, it may initiate a process with a tool call for the one or more tasks. In some cases, the initiation may include using an interactive agent chat prompt, which an AI may determine triggers a tool call.

In some implementations, initiating the process may include determining initial process attributes based on the configuration of the genie or one of its components. Tool calls may be initiated by the AI with dynamic parameters, which may include user inputs, contextual data from the process, or predefined configurations set during the design phase. In some instances, the initial attributes may include some or all of the configurations described above, although other implementations are possible.

For example, the process may be started or resumed, which event may be used to notify UI elements to start the conversation with an end user and set initial process attributes.

In some implementations, at 604, the genie manager 140 may add or update a step of the process, such as where a genie, module, or tool is changed. For instance, an update step may be triggered when a new message is added, a tool call is initiated or completed, or acknowledge retrieval is started or finished. The event may update a UI module and other relevant systems with the latest process details. In some implementations, the update may use the operations described above in reference to the method 600, though other implementations are possible and contemplated herein.

In some implementations, at 606, the genie manager 140 may iteratively evaluate the process including initiating tool call(s) with dynamic parameters. For instance, at run time, the genie manager 140 may send messages to the AI service, wait for statuses or responses, handle tool calls, knowledge retrieval, and user interactions or approvals, as described in further detail elsewhere herein. In some cases, evaluation of the process may include determining user identity, authorization, or approval requirements, as noted below.

In some implementations, at 608, the genie manager 140 may determine whether a user-scoped connection is required/set for the tool/tool call. For instance, responsive to determining that user-specific credentials are associated with the tool, it may determine the user-specific credentials to execute the tool call. The interactive agent may request the user credentials at run time or retrieve credentials from a database (e.g., set at configuration of the tool).

In some implementations, at 610, the genie manager 140 may evaluate approval conditions and/or parameters of the tool call. When an approval rule is defined, this event may be triggered to evaluate the approval condition before proceeding with the tool call. Responsive to determining that an approval rule of the tool is defined, it may evaluate an approval condition. When an approval rule condition returns a status of “requires approval,” the approval tool call event may manage the approval process with designated users. For example, it may detect an approval rule that requires approval by the user or by a certain user, the interactive agent may request user approval. In other instances, the condition may require that a certain user's credentials are provided, such as in a work environment where an administrative approval or login is required.

In some implementations, at 612, the genie manager 140 may execute a tool call for the tool using the user-specific credentials and/or based on the approval condition being satisfied.

In some implementations, where required by the tool, module, or genie, at 614, the genie manager 140, tool, or genie may process and pass the results to the user. In some cases, it may be output on a UI interface defined by another module of the genie. In some cases, the result may be output via a chat interface.

In some cases, if an unexpected error occurs during any part of the process, an error event is triggered to handle the error, provide notifications, and possibly initiate recovery actions.

A processed-stopped event may be triggered when the process completes its execution, and this event may be used for cleanup steps and final notifications. A process-deleted event may handle cleanup steps and provide that related data and resources are properly disposed of, for example, when a thread or process is deleted.

The operations may be augmented with further AI-driven steps. For example, an AI model may be used to receive requests for defining an interactive agent that performs domain-specific tasks. In some implementations, a user may request a certain task be performed, and the AI model may determine which modules or tools are available and, potentially, assist in defining them for the request. In some implementations, a module itself may include tool calls to an AI model or service. In some implementations, a conversational AI module may expose tasks that determine a next step or terminate, explain why a step was taken, or perform other operations.

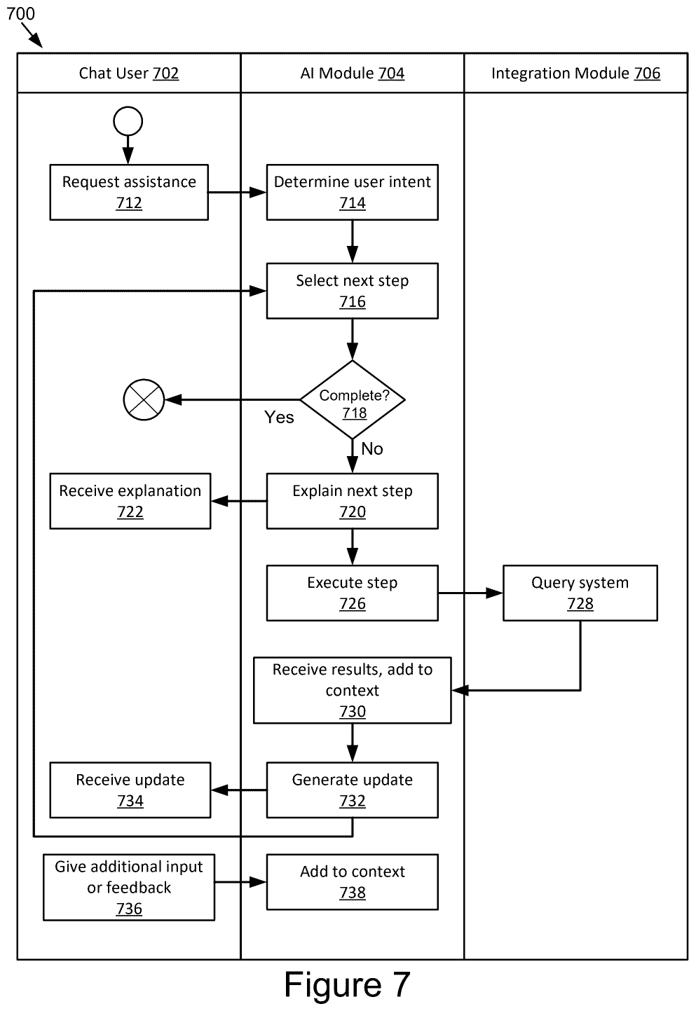

FIG. 7 illustrates a block diagram showing an example method 700 in which an AI generates steps. For instance, these and other features may provide dynamic capabilities to the genie manager platform.

In some implementations, the genie manager 140 may provide AI-driven process steps, such as where the Genie uses AI to determine which internal steps to take and to determine a stopping criterion. This may be supported via conversational AI modules which expose the following tasks including determining which next step to take (or to terminate) and explaining the step that is taken and why.

For example, a problem-diagnostic genie could be supplied, via modules and tasks, access to a software environment such as AWS™. The genie may have available an AI connector and can use it to iteratively determine which step to take to resolve the problem. Those steps could include querying external systems via modules that provide integration capabilities, as well as querying and receiving input from the user. The AI may proceed to generate new steps in the process until it is stopped by user input or determines that no better or additional solutions can be obtained by continuing. The diagram in FIG. 7 illustrates an example process for this procedure.

As illustrated and described herein, multiple bots may interact, such as where genies may form a cooperating set or hierarchy, with individual genies being able to invoke other genies. For example, a first stage assistant genie may field user requests, directing them to another more specialized genie based on the nature of the task. The genie receiving the handoff may be provided with sufficient context to understand the nature of the task, information currently available, actions previously performed, etc.

This example sequence of genie invocations may not be predetermined, but the number and sequence of genies called can be AI-generated, much as was described for a sequence of calling tasks packaged in modules. For instance, a coordinator genie, which has knowledge of other genies and can handle their invocation, with the necessary context switching, may be used.

As described in further detail herein, the platform may provide AI-initiated process generation. For example, genies can be implemented via a low-code/no-code user interface. Through observation of previous interactions within and across genies, a specialized AI process may recognize common patterns in the task sequences that genies generate. Accordingly, this recognition could trigger generation of a new callable process with a deterministic execution path, eliminating the need for repeated inference steps that generate similar results. This materialized process may then become available as an API callable within genies.

While various operations, sequences of operations, and features may be used, an example is provided in the method 700. These operations may be combined or replaced with other operations herein. At 712, a chat user 702 may request assistance from a genie, such as from an AI module 704 of a genie, which may determine user intent 714 based on the user's 702 prompt. Using the user intent, the AI module 704 may select a next step for a genie being created, module being configured, process being programmed, recipe being programmed, etc., at 716. At 718, if the task is complete or the user requests termination, the method 700 may terminate. If more steps are required, the method 700 may proceed to 720.

At 720, the AI module 704 may explain the next step, which was determined, to the user 702 at 722. In some implementations, the AI module 704 may proceed to 724 to execute the step. For instance, the AI module 704 may communicate with an integration module 706 to query a system 728, which may be integrated with the integration module 706 and/or coupled with the integration module 706 via an API. For instance, this step may include determining parameters or details for the step.

At 730, the AI module 704 may receive results and add it to the context. For instance, at 732, it may generate the update and provided it the chat user 702 at 734. If there are additional steps to be determined, they may be selected at 716.

In some implementations, at 736, the chat user 702 may give additional input or feedback to the AI module 704, which may process and add to the context, use to modify the step, or perform another operation at 738.

While many other examples and implementations are possible, examples for using the genie manager 140 platform and associated features are described herein by way of illustration. These are described as distinct examples, but aspects may be modified, combined, interchanged, or omitted.

In a first example, a cloud diagnostic agent may be configured. An IT genie is supplied, via a module and associated tasks, access to query and make changes in a cloud environment such as Amazon Web Services™ (AWS™). A user having a problem initiates interaction with the genie through a chat interface such as Slack™. The genie receives a text description of the problem.

The genie may use an AI system to interactively generate steps that aid in diagnosis and resolution of the problem. At each step it may provide feedback to the user on what actions it is taking, and why. The user may, at any time, provide further chat input, which is incorporated into the context for the running genie and may modify its behavior. Queries into the cloud system may use the user's credentials, so that they can neither see nor modify any cloud virtual features to which they would not normally have access. Actions that require modification of the cloud system may require user confirmation, or even a second- or third-level approval. Steps in the overall process may continue until a stopping condition is reached, which may be the AI deciding that the problem is resolved or that no more fruitful steps can be generated, or it may be terminated by the user indicating the problem is solved or that they do not want to continue the process further.

In a second example, interactive agents may collaborate on a task including automated process generation. For instance, a user may wish to set up an offsite for a remote team and initiate this by sending a request to her personal genie with a list of proposed attendees in her team. The personal genie may have the ability to use an AI service to parse requests and to direct next steps in an overall process, to connect to select corporate applications, and to perform common generative AI functions such as summarizing text.

The user's genie may determine information about the team by accessing each team person's bots, accesses a travel genie with access to a travel site, such as Navan™, to calculate the price for tickets and hotel, and prepares a summary of the offsite. The summary may then be submitted to a corporate policy genie and budget genie, to verify that costs are in line and the offsite is allowed per corporate policies. The results from that check may be condensed into a short summary by the AI service and sent to the user's manager's personal genie for approval.

Based on manager approval, the user's genie may communicate with the genie associated with the travel site to create a trip and generate proposed travel details for each invitee. Notification of those details goes to all team members' personal genies and may be received in the form of a message in the corporate chat application.

Team members may approve the travel details, and the travel site will then be directed to book flights and hotel rooms for them. As travel details are finalized, the user's genie may receive or retrieve information about the bookings.

In some cases, the user's genie can spawn a new genie (e.g., using automated code generation) to handle further communications and logistics related to the event.

A genie supervising overall activity may determine or receive notification that there are multiple similar sequences of events involving creation of a planned trip and, after a certain number of these have been observed, propose to create a process and send these issues to a process genie able to generate new business processes (e.g., recipes, implemented in JSON). The process genie may analyze the text description of the overall sequence of events, create a process description and generate the code for this process. The materialized process then becomes available to genies as an API, for example, as a cheaper/faster alternative to generating process steps via the AI service.

Accordingly, implementations of the technology described herein provide maintenance of a reusable library of callable tools, including facilities for evolution of their schema over time. The technology allows independence from using a particular AI provider or its extension framework. The technology provides a system for coordinating tool calls and knowledge retrieval and for managing user interactions and approvals. The technology may maintain context within and across agents including passing a user context to tool invocations. The technology may also provide higher level coordination and learning functions, such as building a framework of dynamically interacting agents or using past activity to generate new processes.

In the above description, for purposes of explanation, numerous specific details are set forth in order to provide a thorough understanding of the present disclosure. However, it should be understood that the technology described herein can be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services. Thus, it should be understood that a variety of different system environments and configurations are contemplated and are within the scope of the present disclosure. For instance, various functionality may be moved from a server to a client, or vice versa and some implementations may include additional or fewer computing devices, services, and/or networks, and may implement various functionality client or server-side. Further, various entities of the described system(s) may be integrated into to a single computing device or system or additional computing devices or systems, etc. In addition, while the system depicted herein provides an example of an applicable computing architecture, it should be understood that any suitable computing architecture, whether local, distributed, or both, may be utilized in the system.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to a computing device and/or other apparatus for performing the operations herein. This computing device may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of a hardware implementation, a software implementation, or implementations containing both hardware and software elements. For instance, the technology may be implemented in executable software, which includes but is not limited to an application, firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening 1/O controllers.

Communication unit(s) (e.g., network interfaces, etc.) may also be coupled to the system to enable the data processing system to become coupled to other data processing systems, storage devices, remote printers, etc., through intervening private and/or public networks, such as the network 102.

Wireless (e.g., Wi-Fi™) transceivers, Ethernet adapters, and modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats.

Furthermore, the modules, routines, features, attributes, methodologies and other aspects of the disclosure can be implemented as software, hardware, firmware, or any combination of the foregoing. Also, wherever a component, an example of which is a module, of the specification is implemented as software, the component can be implemented as a standalone program, as part of a larger program, as a collection of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment.

What is claimed is:

1. A computer-implemented method comprising:
initiating, by one or more processors, generation of an interactive agent to perform one or more tasks, the interactive agent including at least one module of a set of modules, each of the set of modules providing a tool configured to perform a task;
determining, by the one or more processors, the at least one module for the interactive agent including selecting the at least one module from among the set of modules; and
initiating, by the one or more processors, a process of the interactive agent to perform the one or more tasks using the at least one module.

2. The computer-implemented method of claim 1, further comprising:
determining, by the one or more processors, a design-time update to the at least one module of the interactive agent;
based on determining the design-time update, triggering, by the one or more processors, a reindexing process for the at least one module;
propagating, by the one or more processors, a configuration update across a plurality of affected interactive agents including the interactive agent, the plurality of affected interactive agents including the at least one module; and
applying, by the one or more processors, a function state in a function state table indicating the design-time update for the at least one module.

3. The computer-implemented method of claim 2, wherein the reindexing process includes:
suspending, by the one or more processors, a definition of the interactive agent;
executing, by the one or more processors, an updated module based on the configuration update; and
resuming, by the one or more processors, the definition of the interactive agent.

4. The computer-implemented method of claim 1, further comprising:
determining, by the one or more processors, a run-time update to a component of the interactive agent;
based on determining the run-time update, suspending, by the one or more processors, at least one process of the interactive agent; and
broadcasting, by the one or more processors, one or more events to one or more software recipes associated with a plurality of affected interactive agents including the interactive agent, the one or more events indicating a configuration update.

5. The computer-implemented method of claim 1, wherein:
the set of modules are interchangeable in the interactive agent to affect a plurality of tasks of the interactive agent, the at least one module including a defined input/output schema that connects the at least one module to an external service used to perform the task.

6. The computer-implemented method of claim 1, further comprising:
initiating, by the one or more processors, the task of the tool of the at least one module including determining initial process attributes;
based on determining that user-specific credentials are associated with the tool, determining, by the one or more processors, the user-specific credentials; and
executing, by the one or more processors, a tool call for the tool using the user-specific credentials, the task including executing the tool call.

7. The computer-implemented method of claim 1, further comprising:
based on determining that an approval rule of the tool is defined, evaluating, by the one or more processors, an approval condition for the approval rule; and
executing, by the one or more processors, a tool call for the tool based on the approval condition being satisfied.

8. The computer-implemented method of claim 1, wherein:
the interactive agent includes a specialized digital assistant configured to perform one or more domain-specific tasks, the interactive agent including a plurality of modules combined to perform the one or more tasks, each of the set of modules including a tool with a defined input/output schema that uses a runtime connection for a user.

9. The computer-implemented method of claim 8, wherein:
the interactive agent is configured to retrieve data from and store data to one or more third-party databases using the defined input/output schema.

10. The computer-implemented method of claim 1, wherein:
the interactive agent includes a chat interface configured to receive user input via a chat prompt, identify the task based on the chat prompt, and perform one or more tool calls to perform the task.

11. The computer-implemented method of claim 1, wherein:
the at least one module of the interactive agent includes a plurality of artificial intelligence modules, each of the plurality of artificial intelligence modules interacting with an artificial intelligence model, the plurality of artificial intelligence modules being communicatively coupled with each other to perform the one or more tasks.

12. A system comprising:
one or more processors; and
a computer-implemented memory storing instructions that, when executed by the one or more processors, causes the system to perform operations comprising:
initiating, by the one or more processors, generation of an interactive agent to perform one or more tasks, the interactive agent including at least one module of a set of modules, each of the set of modules providing a tool configured to perform a task;
determining, by the one or more processors, the at least one module for the interactive agent including selecting the at least one module from among the set of modules; and
initiating, by the one or more processors, a process of the interactive agent to perform the one or more tasks using the at least one module.

13. The system of claim 12, wherein the operations further comprise:
determining, by the one or more processors, a design-time update to the at least one module of the interactive agent;
based on determining the design-time update, triggering, by the one or more processors, a reindexing process for the at least one module;
propagating, by the one or more processors, a configuration update across a plurality of affected interactive agents including the interactive agent, the plurality of affected interactive agents including the at least one module; and
applying, by the one or more processors, a function state in a function state table indicating the design-time update for the at least one module.

14. The system of claim 13, wherein the reindexing process includes:
suspending, by the one or more processors, a definition of the interactive agent;
executing, by the one or more processors, an updated module based on the configuration update; and
resuming, by the one or more processors, the definition of the interactive agent.

15. The system of claim 12, wherein the operations further comprise:
determining, by the one or more processors, a run-time update to a component of the interactive agent;
based on determining the run-time update, suspending, by the one or more processors, at least one process of the interactive agent; and
broadcasting, by the one or more processors, one or more events to one or more software recipes associated with a plurality of affected interactive agents including the interactive agent, the one or more events indicating a configuration update.

16. The system of claim 12, wherein:
the set of modules are interchangeable in the interactive agent to affect a plurality of tasks of the interactive agent, the at least one module including a defined input/output schema that connects the at least one module to an external service used to perform the task.

17. The system of claim 12, wherein the operations further comprise:
initiating, by the one or more processors, the task of the tool of the at least one module including determining initial process attributes;
based on determining that user-specific credentials are associated with the tool, determining, by the one or more processors, the user-specific credentials; and
executing, by the one or more processors, a tool call for the tool using the user-specific credentials, the task including executing the tool call.

18. The system of claim 12, wherein the operations further comprise:
based on determining that an approval rule of the tool is defined, evaluating, by the one or more processors, an approval condition for the approval rule; and
executing, by the one or more processors, a tool call for the tool based on the approval condition being satisfied.

19. The system of claim 12, wherein:
the interactive agent includes a specialized digital assistant configured to perform one or more domain-specific tasks, the interactive agent including a plurality of modules combined to perform the one or more tasks, each of the set of modules including a tool with a defined input/output schema that uses a runtime connection for a user.

20. The system of claim 19, wherein:
the interactive agent is configured to retrieve data from and store data to one or more third-party databases using the defined input/output schema.
